(19) United States
(12) Patent Application Publication
(10) Pub. No.: US 2021/0115278 A1
(43) Pub. Date: Apr. 22, 2021

(54) BIO-BASED POLYURETHANE RESIN, BIO-BASED POLYURETHANE RESIN SOLUTION, AND PRINTING INK

(71) Applicant: DAINICHISEIKA COLOR & CHEMICALS MFG. CO., LTD., Tokyo (JP)

(72) Inventors: Iwao MISAIZU, Tokyo (JP); Hiromasa SATO, Tokyo (JP); Motoaki UMEZU, Tokyo (JP); Hiroki GOTO, Tokyo (JP); Tomoyuki NATSUI, Tokyo (JP)

(21) Appl. No.: 16/606,591

(22) PCT Filed: Apr. 24, 2018
(86) PCT No.: PCT/JP2018/016596

§ 371 Date: Oct. 18, 2019

(30) Foreign Application Priority Data
Apr. 26, 2017 (JP) 2017-087370

(51) Int. Cl. C09D 11/102; C08G 18/68; C08G 63/553; C08L 75/06; C09D 11/037; C08G 18/75

(52) U.S. Cl. CPC C09D 11/102; C08G 18/68; C08G 18/757; C08L 75/06; C09D 11/037; C08G 63/553

(57) ABSTRACT

Provided are: a polyurethane resin having a high degree of biomass, the polyurethane resin useful as a binder for a printing exhibiting excellent adhesion performance particularly to biomass plastic base materials and having excellent dispersibility of a pigment contained at a high concentration; and a printing ink using the polyurethane resin. A bio-polyurethane resin obtained by reacting a bio-polyol (A) and an isocyanate (B), wherein the (A) is a bio-polyester polyol being a polymerized product of a diol component (a) and a dicarboxylic acid component (b) each containing a plant-derived component, the (a) contains at least one selected from ethylene glycol, 1,2-propanediol, 1,3-propanediol, 1,4-butanediol, 1,10-decanediol, and dimer diols each derived from a plant, the (b) contains plant-derived succinic acid and an additional dicarboxylic acid, and plant-derived succinic acid/additional carboxylic acid=98/2 to 5/95, and a content of plant-derived components is 35% or more based on 100% by mass of the bio-polyurethane resin, and a printing ink.

### TECHNICAL FIELD

The present invention relates to a bio-polyurethane resin, a polyurethane resin solution, and a printing ink each using biomass as a raw material. In detail, the present invention relates to a technique for providing a bio-polyurethane resin and a liquid bio-polyurethane resin each capable of being utilized suitably as a binder for an organic solvent type printing ink and each having a high degree of biomass. As preferred embodiments thereof, the present invention relates to a technique capable of providing a printing ink being so-called non-toluene solvent-based or non-toluene, non-MEK (methyl ethyl ketone) solvent-based, having excellent adhesion performance, pigment dispersibility, and printability, and having a high degree of biomass by using an organic solvent mainly containing an ester-based solvent or an alcohol solvent as an organic solvent constituting a resin solution from the viewpoint of dealing with environmental problems, such as a bad odor and safety. In the present invention, not only a polyurethane obtained by a reaction of an isocyanate compound and a hydroxy compound and having repeated urethane bonds but also a resin obtained by a reaction of an isocyanate compound and an amine compound and having an urea bond are referred to as the “polyurethane resin”.

### BACKGROUND ART

In recent years, biomass being organism-derived resources excluding fossil resources has attracted attention as industrial resources which are not exhaustible resources. A plant in particular absorbs CO₂ in the atmosphere and grows by photosynthesis using sunlight as energy, and therefore it is considered that products (such as biomass plastics, synthetic fibers, and printing inks) produced from a plant-derived raw material give no influence on increase and decrease of CO₂ in the atmosphere (carbon neutral) because the amount of CO₂ absorbed due to photosynthesis in the growth process of plants and the amount of CO₂ discharged by incineration of plants are offset, and the development of such products is expected. Among the products using a plant-derived raw material, the development and utilization of Biomass Mark-certified goods, which will be described later, are desired from the background that those goods are safe, contribute to formation of recycling society, and are useful for prevention of global warming.

In addition, a polyurethane resin is basically obtained by reacting a high-molecular-weight polyol component, an organic polyisocyanate component, and, as necessary, a polyamine chain extender component, and polyurethane resins having various types of performance (physical properties) can be provided by changing the types and combination of these components. Particularly, a printing ink using a solution of a polyester-based polyurethane resin containing an active amino group at a terminal thereof as a binder for a printing ink is useful in terms of excellent adhesion performance to various plastic base materials and pigment dispersibility.

However, most of printing inks using a polyurethane resin as a binder have a life cycle in which raw materials are procured from petroleum resources, materials are produced, used, and finally incinerated as waste, and from this point of view, improvements in consideration of ecology are demanded. Facing such demand, printing inks up until now in consideration of ecology have been insufficient in conventional functionalities, such as an adhesion property, pigment dispersibility, and printability, and besides, the “degree of biomass” indicating the amount of organism-derived resources.

Recently, biomass plastic films, such as polyethylene terephthalate (PET), nylon (NY), polypropylene (PP), polyethylene (PE) films, which can be applied to soft packaging applications represented by food packaging and the like and which utilize plant-derived raw materials have begun to be sold on the market in addition to polylactic acid films which have frequently been used as plant-derived biomass films in the past. In addition, with respect to ink layers formed on plastic base materials containing these biomass plastic base materials, biomass ink layers are desired, and besides, binders for non-toluene solvent-based or non-toluene, non-MEK solvent-based printing inks not using toluene or a methyl ethyl ketone (hereinafter, abbreviated as MEK) solvent are demanded. Moreover, in the case where a polyurethane resin containing a plant-derived raw material is used as a binder, and further, in the case where a non-toluene solvent-based or non-toluene, non-MEK solvent-based binder is used, as well as in the case where a conventional petroleum-derived polyurethane resin binder is used, a printing ink having high adhesion strength, excellent pigment dispersibility, and excellent printability is desired.

Under the above-described current circumstances, as a binder for a printing ink, the binder using a plant-derived component as a raw material for production, for example, a polyurethane resin using a polyester polyol obtained from a plant-derived dimer acid is known (Patent Literature 1). In addition, a printing ink (Patent Literature 2) by which printability, such as a plate-clogging property, is improved by using, as a binder for a printing ink, a polyurethane resin in which the amount of use of a polyester obtained from a plant-derived dimer acid is reduced is also known.

On the other hand, as described previously, utilization of biomass has been studied on a global scale, development of printing inks using, as a binder for dispersing a pigment, a polyurethane resin having excellent functionalities and degree of biomass has been hoped for, and if such printing inks can be realized, they are extremely useful. From the above-described technological trend in recent years, in the case where the degree of biomass in the solid content of a printing ink is 10% by mass or more, there is a background that if the printing ink satisfies the other requirements, such as safety/security as an environmentally friendly product, the printing ink can receive “Biomass Mark” certification from Japan Organics Recycling Association (Non Patent Literature 1). To achieve this, development of an industrially applicable, useful technique by which a high degree of biomass, as high as 35% by mass or more, more suitably as high as 40% by mass or more, is realized in a polyurethane resin to be a raw material for a binder is hoped for.

### CITATION LIST

### Patent Literature

Patent Literature 1: Japanese Patent Laid-Open No. 2-189375

Patent Literature 2: Japanese Patent Laid-Open No. 2003-41175

### Non Patent Literature

Non Patent Literature 1: Japan Organics Recycling Association HP, “Biomass Mark: Notice of Revision of Certification Review Outline, and Rules”, Internet <URL:http://www.jora.jp/txt/katsudo/bm/biomassmark01.html>

### SUMMARY OF INVENTION

### Technical Problem

However, the ink using the above-described resin described in Patent Literature 1 as a binder for dispersing a pigment has excellent adhesive force and boiling resistance as an ink for printing on a plastic film for packaging, but has large environmental load and inferior printability because the printing ink is toluene-containing solvent-based, and therefore further improvements are demanded. The object of the technique described in Patent Literature 2 is not biomass, and therefore the degree of biomass as an ink has been insufficient.

From the previously described circumstances, a high-performance printing ink having a degree of biomass of 10% by mass or more, having excellent practical performance, such as adhesion performance, pigment dispersibility, and printability, and being non-toluene solvent-based or non-toluene, non-MEK solvent-based is extremely useful in the industrial material fields in which environmental aspects are thought to be more important. In the case of a printing ink, as represented by a white ink, a pigment is blended at a very high concentration. To make the amount of the biomass component in the solid content of a printing ink 10% by mass or more stably while dealing with a change in requirements for a color tone by the pigment blended at a high concentration, there is a need to practically make the degree of biomass in a polyester-based urethane resin binder to be used 35% by mass or more, further, 40% by mass or more. However, according to studies conducted by the present inventors, when the degree of biomass of a urethane resin binder for a printing ink is made 35% by mass or more using the dimer acid-modified polyester polyol described in Patent Literature 1, the status has been such that the adhesion performance of the final printing ink is obtained, but the pigment dispersibility and the printability are inferior, so that the printing ink lacks in practicability. In addition, as described previously, resin binders in the old techniques are toluene-containing solvent-based, and therefore a binder material for a so-called non-toluene solvent-based or non-toluene, non-MEK solvent-based printing ink having a high degree of biomass, the printing ink not containing a toluene-based solvent is demanded from the viewpoint of dealing with environmental problems, such as a bad odor and safety.

Accordingly, an object of the present invention is to provide a polyurethane resin containing a high degree of biomass, the polyurethane resin useful as a binder for a printing ink having printability, such as exhibiting excellent adhesion performance to various plastic base materials, particularly to biomass plastic base materials, and having excellent dispersibility of a pigment contained at a high concentration. In addition, another object of the present invention is to provide a printing ink having a degree of biomass of 10% by mass or more, which is a certification criterion for “Biomass Mark”, the printing ink being extremely useful in the fields where environmental conservation aspects are required from the idea of carbon neutral by using a bio-polyurethane resin as a binder for a printing ink. Further, yet another object of the present invention is to enable providing a non-toluene solvent-based or non-toluene, non-MEK solvent-based printing ink by using the polyurethane resin. Further, still another object of the present invention is to provide a bio-polyurethane resin, when applied to a printing ink, that has excellent compatibility with printing inks which have been used earlier in a printing apparatus; that can reduce load on washing inside a printing apparatus, which brings about a problem when printing inks are changed in the process of printing operation; and that is therefore more useful as a binder for a printing ink.

### Solution to Problem

The above-described problems are solved by the present invention constituted as described below.

[1] A bio-polyurethane resin obtained by reacting a bio-polyol component (A) and an isocyanate component (B), wherein: the bio-polyol component (A) is a bio-polyester polyol being a polymerized product of a multifunctional alcohol component and a multifunctional carboxylic acid component, the polymerized product obtained from a raw material comprising: a diol component (a) comprising a plant-derived component; and a dicarboxylic acid component (b) comprising a plant-derived component; the diol component (a) comprises at least one selected from the group consisting of ethylene glycol, 1,2-propanediol, 1,3-propanediol, 1,4-butanediol, 1,10-decanediol, and dimer diols each derived from a plant; the dicarboxylic acid component (b) comprises plant-derived succinic acid and an additional dicarboxylic acid, and a molar ratio thereof, plant-derived succinic acid/additional carboxylic acid, is 98/2 to 5/95; and a content of plant-derived components is 35% by mass or more based on 100% by mass of the bio-polyurethane resin.

Preferred embodiments of the above-described bio-polyurethane resin according to the present invention include those described below. It is to be noted that an active amino group as referred to in the present invention is a primary or secondary amino group having active hydrogen.

[2] The bio-polyurethane resin according to [1], wherein the additional dicarboxylic acid is at least any one of plant-derived sebacic acid or dimer acids.

[3] The bio-polyurethane resin according to [1] or [2], further comprising a polyamine component (C) as a reaction component and having a urethane urea bond in a structure thereof.

[4] The bio-polyurethane resin according to [3], having an active amino group at a terminal thereof, wherein the terminal active amino group has a concentration of 15 to 100μ equivalent per 1 g of a solid content of the bio-polyurethane resin.

[5] The bio-polyurethane resin according to any one of [1] to [4], further comprising an organic solvent, wherein: the bio-polyurethane resin is dissolved in the organic solvent and is in a form of a solution; and the organic solvent does not contain toluene or does not contain any of toluene and MEK.

The above-described problems are solved by the present invention constituted separately as described below.

[6] A bio-polyurethane resin solution being a polyester-based polyurethane resin solution comprising: a polyester-based polyurethane resin obtained by polymerizing a polyester polyol, an organic diisocyanate, and a polyamine, having a urethane urea bond in a structure thereof, and having an active amino group at a terminal thereof; and an organic solvent, wherein: the polyester polyol is a polymerized product of a multifunctional carboxylic acid component and a multifunctional alcohol component each obtained from a raw material for synthesis comprising a plant-derived component; the multifunctional carboxylic acid component comprises a dimer acid and succinic acid in a range where a molar ratio of plant-derived succinic acid/dimer acid is 98/2 to 5/95, and the multi-functional alcohol component comprises 1,3-propanediol; and a proportion of plant-derived components in a solid content of the polyester-based polyurethane resin having an active amino group at a terminal thereof is 35% by mass or more.

Preferred embodiments of the bio-polyurethane resin solution according to the present invention include those described below.

[7] The bio-polyurethane resin solution according to [6], wherein part of or all of the succinic acid is a plant-derived component, and part of or all of the dimer acid is a plant-derived component and/or part of or all of the 1,3-propanediol is a plant-derived component.

[8] The bio-polyurethane resin solution according to [6] or [7], wherein the terminal active amino group in the polyester-based polyurethane resin having the active amino group at the terminal thereof has a concentration of 15 to 100μ equivalent per 1 g of a solid content of the polyester-based polyurethane resin.

[9] The bio-polyurethane resin solution according to any one of [6] to [8], wherein the organic solvent does not contain toluene or does not contain any of toluene and MEK.

[10] The bio-polyurethane resin solution according to any one of [6] to [8], wherein the organic solvent is a mixed solvent of ethyl acetate and isopropyl alcohol, or a mixed solvent of ethyl acetate, isopropyl alcohol, and MEK.

The present invention provides as another embodiment [11] A printing ink comprising: a pigment; and a binder for a printing ink, wherein the printing ink comprises the bio-polyurethane resin in the form of a solution according to [5] or the bio-polyurethane resin solution according to any one of [6] to [10] in an amount such that a proportion of plant-derived components in a solid content of the ink is 10% by mass or more as the binder for a printing ink.

Preferred embodiments of the printing ink according to the present invention include those described below.

[12] The printing ink according to [11], to be used for gravure printing, flexographic printing, screen printing, offset printing, or inkjet printing.

[13] The printing ink according to [11] or [12], to be used for printing onto a film package, a paper package, a building material, or tissue paper.

### Advantageous Effects of Invention

According to the present invention, provided is a bio-polyurethane resin that can be utilized as a binder for a printing ink exhibiting excellent adhesion performance to various plastic base materials, particularly to biomass plastic base materials, and having excellent dispersibility of a pigment contained at a high concentration, and that has a degree of biomass of 35% by mass or more, and further, 40% by mass or more, the bio-polyurethane resin containing a high degree of plant-derived components (biomass). In addition, according to the present invention, using this polyurethane resin containing a high degree of biomass as a binder for a printing ink enables providing a printing ink extremely useful in the fields where environmental conservation aspects are required from the idea of carbon neutral, the printing ink having a degree of biomass of 10% by mass or more being a certification criterion for “Biomass Mark”, obtained by dispersing a high concentration of a pigment, and having excellent practical performance such as adhesion performance, pigment dispersibility, and printability. Further, according to the preferred embodiments of the present invention, a printing ink not containing a toluene-based solvent, a so-called non-toluene solvent-based or non-toluene, non-MEK solvent-based printing ink is provided by using the bio-polyurethane resin.

The printing ink obtained by applying the bio-polyurethane resin provided by the present invention and having a high degree of biomass to a binder has excellent practical performance, such as adhesion performance, pigment dispersibility, and printability, although the printing ink contains 10% by mass or more of plant-derived components in the solid content of the ink, and can be applied to printing on various biomass plastic films, such as plant-derived biomass polyesters (polylactic acid, biomass PET, polybutylene succinate, polyhydroxybutyrate, polytrimethylene terephthalate, and others), biomass nylon, biomass polyethylene, and biomass polypropylene, and plant-derived paper, on which the development has been active and made into practical use recently. In addition, lamination of the bio-polyurethane resin provided by the present invention and having a high degree of biomass with any of the various biomass plastic films and plant-derived paper, as described above, plant-derived fiber cloth, and a metal foil using a biomass adhesive enables making a laminated body into a bio-material all over the laminated body excluding a metal part, and enables making the bio-polyurethane resin into a biomass printed, lamination-processed product useful in various industrial material fields, such as food packaging, pharmaceutical product packaging PTP (Press Through Package) sheets, home electric appliances, and clothes, from the viewpoint of environmental conservation in terms of carbon neutral. As described previously, a printing ink having a degree of biomass of 10% by mass or more can receive “Biomass Mark” certification from Japan Organics Recycling Association if the printing ink satisfies the other requirements. Meanwhile, the printing ink provided by the present invention has a degree of biomass of 10% by mass or more and can be an object of the “Biomass Mark” certification, and therefore is also useful from the viewpoint of global environmental protection, and putting the printing ink provided by the present invention into practical use is desired.

### DESCRIPTION OF EMBODIMENTS

Next, the present invention will be described in more detail giving preferred embodiments for carrying out the present invention.

### <Polyurethane Resin>

A polyurethane resin according to the present invention is characterized in containing a bio-polyurethane resin obtained by reacting a bio-polyol component (A), an isocyanate component (B) such as a diisocyanate, and a polyamine component (C) used as necessary, and containing a high degree of biomass components, as high as having the content of plant-derived components in the solid content of the resin of 35% by mass or more, and further, 40% by mass or more. The bio-polyol component (A) constituting the polyurethane resin according to the present invention is a bio-polyester polyol being a polymerized product of a multifunctional alcohol component and a multifunctional carboxylic acid component, the polymerized product obtained from essential raw material components containing a diol component (a) containing a plant-derived component and a dicarboxylic acid component (b) containing a plant-derived component, wherein the diol component (a) contains at least one selected from ethylene glycol, 1,2-propanediol, 1,3-propanediol, 1,4-butanediol, 1,10-decanediol, and dimer diols each derived from a plant, further, the dicarboxylic acid component (b) contains plant-derived succinic acid and an additional dicarboxylic acid, and a molar ratio thereof, plant-derived succinic acid/additional dicarboxylic acid, is 98/2 to 5/95. Suitable examples of the additional dicarboxylic acid include sebacic acid and dimer acids each derived from a plant.

In the case of the constitution in which the polyamine component (C) is used as the reaction component, a bio-polyurethane resin having a structure having an active amino group at a terminal thereof is preferably made. In this case, a bio-polyurethane resin having a urethane urea bond in the structure thereof is made. Specifically, the polyurethane resin having an active amino group at a terminal thereof is easily obtained by, for example, reacting the bio-polyester polyol specified above and a diisocyanate to produce a prepolymer having a terminal isocyanate, and then subjecting the isocyanate group in the produced prepolymer to a chain extending reaction with an excess amount of a polyamine such as a diamine. As a binder for a printing ink, the polyurethane resin is provided in the form such that the polyurethane resin is dissolved in an organic solvent. The active amino group above means amino groups having active hydrogen, namely, primary and secondary amino groups.

A solution of the bio-polyurethane resin having a urethane urea bond in the structure of the resin, which is one of the embodiments according to the present invention, is characterized by containing: a polyester-based polyurethane resin obtained by polymerizing a polyester polyol, an organic diisocyanate, and a polyamine and having an active amino group at a terminal thereof; and an organic solvent, and containing a high degree of biomass, as high as a proportion of plant-derived components in the solid content of the polyester-based polyurethane resin having an active amino group at a terminal thereof of 35% by mass or more, and further, 40% by mass or more. Further, the bio-polyurethane resin solution is characterized in that the polyester polyol constituting the bio-polyurethane resin solution according to the present invention is a polymerized product of a multifunctional carboxylic acid component and a multifunctional alcohol component each obtained from a raw material for synthesis containing a plant-derived component, the multifunctional carboxylic acid component contains a dimer acid and succinic acid in a range where the molar ratio of succinic acid/dimer acid is 98/2 to 5/95, and the multifunctional alcohol component contains 1,3-propane diol. Hereinafter, components constituting the polyurethane resin according to the present invention will be described in more detail.

[Bio-Polyol Component (A)]

The bio-polyester polyol being a bio-polyol component (A) which is an essential material for synthesizing the polyurethane resin according to the present invention is a polymerized product of a multifunctional carboxylic acid component and a multifunctional alcohol component. In the present invention, the content ratio of the plant-derived components is required to be 35% by mass or more, and more suitably 40% by mass or more to 100% by mass of the bio-polyurethane resin, and therefore, as specified in the present invention, a multifunctional carboxylic acid and a multifunctional alcohol component each containing a plant-derived component also need to be used for the bio-polyester polyol constituting the present invention.

In the present invention, the object is that the proportion of the plant-derived components in the solid content of the bio-polyurethane resin is such that the high degree of biomass, described above, is realized, and therefore a polymeric diol, such as a polycarbonate diol obtained from a plant-derived component or polyoxytetramethylene glycol obtained from a plant-derived component, which is commercially available under present circumstances can be used together with the bio-polyester polyol which contains a large amount of plant-derived components specified in the present invention within a range where the performance of the polyurethane resin finally obtained is not impeded.

The number average molecular weight of the bio-polyester polyol constituting the present invention is preferably 500 or more and 6000 or less. When the number average molecular weight is less than 500, the redissolvability of a resultant polyurethane resin to a solvent is poor, and therefore there is a possibility that when the polyurethane resin is applied to a binder resin in a printing ink, high-speed printability in particular is hard to obtain. On the other hand, when the number average molecular weight exceeds 6000, the heat resistance of a resultant polyurethane resin is poor, and therefore there is a possibility that when the polyurethane resin is applied to a binder resin in a printing ink, the blocking resistance at the time of winding, which is demanded of a printing ink, is hard to obtain. Hereinafter, the raw material components necessary for obtaining the bio-polyester polyol constituting the present invention will be described in detail.

(Plant-Derived Diol Component (a))

As the diol component (a) which is a multifunctional alcohol component to be used for synthesizing the above-described bio-polyester polyol, at least one selected from the group consisting of ethylene glycol, 1,2-propanediol, 1,3-propanediol, 1,4-butanediol, 1,10-decanediol, and dimer diols each being a plant-derived component is used. Among these, ethylene glycol, 1,2-propanediol, 1,3-propanediol, and 1,4-butanediol each derived from a plant are preferable, and particularly, 1,2-propanediol and 1,3-propane diol are preferable. These may be used singly, or in combinations of two or more thereof. When plant-derived 1,2-propane diol or 1,3-propane diol is used as the raw material for synthesizing the polyester polyol constituting the present invention, the content of these in the plant-derived, multifunctional alcohol component as described above is preferably 10 mol % or more, and further, preferably 50 mol % or more. That is, it has been found that such constitution makes the balance among pigment dispersibility, printability, and an adhesion property to a film base material favorable when an ink is made applying a finally obtained polyurethane resin to a binder.

Further, according to studies conducted by the present inventors, when the bio-polyurethane resin obtained by using 1,2-propanediol or 1,3-propanediol, derived from a plant, for synthesizing the bio-polyester polyol constituting the bio-polyurethane resin is applied to a binder for a printing ink, an effect of having excellent compatibility with printing inks which have been used earlier in a printing apparatus is obtained. By this new effect of having excellent compatibility with conventional petroleum-based printing inks, the printing ink according to the present invention can realize an unconventional effect of capable of reducing operational load on washing inside the printing apparatus and replacing inks, which bring about a problem when printing inks are changed in the process of printing operation. This effect brings about not only reduction in operational labor but also reduction in materials necessary for washing and replacing inks and is extremely useful from industrial viewpoint.

With respect to the plant-derived diol components, described above, for use as the diol component (a) in the present invention, those each obtained in the manner as described below are sold on the market. It is to be noted that in the present invention, a plant-derived component is explicitly expressed by “plant-derived, or derived from a plant” or the prefix, bio-, attached to a component name, and is thereby distinguished from a petroleum-derived, usual component. Bio-ethylene glycol is synthesized from bioethanol, which is obtained by fermenting glucose obtained from molasses or the like, via ethylene. Bio-1,2-propanediol is synthesized from natural fat and oil-derived glycerin (by-product of biodiesel; or the like). Bio-1,3-propanediol is synthesized from glucose by a fermentation process via glycerin, 3-hydroxypropyl aldehyde. Bio-1,4-butanediol is produced by reducing bio-succinic acid obtained from glucose by a fermentation process. Bio-1,10-decanediol is obtained by reducing sebacic acid obtained from castor oil extracted from the seed of castor oil plant. A dimer diol is obtained by reducing a dimer acid being a dicarboxylic acid having 36 carbon atoms obtained by dimerizing an unsaturated fatty acid having 18 carbon atoms, such as oleic acid or linoleic acid. Of course, the production methods are not limited to the above-described production methods, and a diol component obtained from a plant raw material can appropriately be utilized.

(Dicarboxylic Acid Component (b))

In the present invention, as the dicarboxylic acid component (b) which is a multifunctional carboxylic acid component to be used for synthesizing the bio-polyester polyol, at least plant-derived succinic acid is used. Examples of the plant-derived dicarboxylic acid component other than bio-succinic acid that is essential in the present invention include glutaric acid, sebacic acid, and dimer acids. These bio-dicarboxylic acids can be each obtained from a plant-derived raw material as described previously. In addition, as described previously, in the present invention, the constitution is made in such a way that it is essential to use at least plant-derived succinic acid as the dicarboxylic acid component (b), and, further, succinic acid is used together with the additional dicarboxylic acid so that the molar ratio of plant-derived succinic acid and the additional dicarboxylic acid will be bio-succinic acid/additional dicarboxylic acid=98/2 to 5/95. As the additional carboxylic acid, plant derived dicarboxylic acids as described above are preferably used in order to enable realizing a higher degree of biomass than the degree of biomass specified in the present invention. However, a high degree of biomass of 35% by mass or more, and, further, 40% by mass or more, which is the object of the present invention, may be realized, and a petroleum-derived dicarboxylic acid component may be contained. When the bio-polyurethane resin according to the present invention is constituted using a petroleum-derived dicarboxylic acid component, material costs can be reduced because under current circumstances, costs for plant-derived materials are higher as compared to the costs for petroleum-based materials.

The bio-polyurethane resin according to the present invention needs to be constituted in such a way that as described above, the dicarboxylic acid component (b) to be used for synthesizing the bio-polyester polyol which is a raw material contains plant-derived succinic acid, and the molar ratio of plant-derived succinic acid/additional carboxylic acid is 98/2 to 5/95. According to studies conducted by the present inventors, for example, two types of different dicarboxylic acid components, as described below, are preferably combined in the above-described molar ratio. Specific examples of the combination include a combination of plant-derived succinic acid and petroleum-derived adipic acid, a combination of plant-derived succinic acid and a plant-derived dimer acid, and a combination of plant-derived succinic acid and plant-derived sebacic acid.

According to studies conducted by the present inventors, when synthesis is performed using a combination in which the molar ratio of bio-succinic acid/additional dicarboxylic acid such as a dimer acid does not satisfy the requirement of 5/95, for example, a combination in which the amount of the additional dicarboxylic acid such as a dimer acid exceeds 95 mol %, and the amount of bio-succinic acid is less than 5 mol %, it is difficult to obtain a polyurethane resin having a high degree of bio-mass intended in the present invention in the case where a petroleum-derived component is used as the additional dicarboxylic acid. In addition, when synthesis is performed without satisfying a molar ratio of bio-succinic acid/dimer acid of 98/2, for example, using 100 mol % of bio-succinic acid without using the additional dicarboxylic acid such as a dimer acid, the crystallinity of a resultant polyester polyol is strong, and therefore the intended polyurethane, when made into a solution, tends to aggregate and precipitate easily. Therefore, when the obtained bio-polyurethane resin is used as a pigment dispersion binder to be made into a printing ink, and this printing ink is utilized for gravure printing or the like, the redissolvability in a process of drying and redissolution of the ink on a plate during rotation of the gravure plate is poor, so that the ink tends to be inferior in liquid stability as the printing ink and is liable to aggregate ununiformly, resulting in being inferior in printability. In the present invention, more preferred molar ratio of bio-succinic acid/additional dicarboxylic acid is in a range of 98/2 to 10/90.

It is to be noted that, according to studies conducted by the present inventors, when a dimer acid obtained from a plant-derived component is used as the additional dicarboxylic acid component, it has been found that the following points have to be noted. A bio-dimer acid contains a trimer as an impurity together with a monomer. Obtaining a polyurethane resin using a polyester polyol obtained from a dimer acid containing a large amount of the trimer component leads to a factor of instability, such as three-dimensional crosslinking gelation, of the resin solution. Therefore, when a bio-dimer acid is used, it may be noted to use a bio-dimer acid having a purity of 95% by mass or more.

As described previously, in the present invention, it is essential that the multifunctional carboxylic acid to be used for synthesizing the bio-polyester polyol contain plant-derived succinic acid, and from the object of obtaining a polyurethane resin in which a high degree of biomass, as high as 35% by mass or more, and further, 40% by mass or more, has been realized, plant-derived components are preferably used as many as possible. Specific examples of the plant-derived, multifunctional carboxylic acid component for use in the present invention include bio-dimer acids each being a dimer made using plant-derived linoleic acid and oleic acid each as a raw material, bio-succinic acid made from a raw material such as corn-derived glucose, bio-sebacic acid obtained from castor oil extracted from the seed of castor oil plant, and plant-derived glutaric acid. However, the present invention is not limited to these plant-derived components. Adipic acid or the like, which will be described later, being a petroleum-derived, multifunctional carboxylic acid can be used together in a range where the performance is consistent with the intended purposes of the present invention and where the performance is not impeded. The important thing in the present is that the constitution is such that the multifunctional carboxylic acid component for synthesizing the polyester polyol for use in the present invention contains bio-succinic acid and the additional dicarboxylic acid component in the molar ratio specified in the present invention, and the proportion of the plant-derived components in the finally obtained polyurethane resin is 35% by mass or more, and further, 40% by mass or more.

According to studies conducted by the present inventors, when a bio-dimer acid and bio-succinic acid are used each as a raw material for synthesizing the bio-polyester polyol constituting the present invention, the total content of the bio-dimer acid and bio-succinic acid in the plant-derived, multifunctional carboxylic acid as described above is preferably set to 30 mol % or more, and, further, preferably set to 40 mol % or more. That is, it has been found that such constitution makes the balance among pigment dispersibility, printability, and an adhesion property to a film base material favorable when an ink is made applying a finally obtained polyurethane resin to a binder.

The polyurethane resin according to the present invention is a polyester-based polyurethane resin obtained by polymerizing: the above-described bio-polyester polyol, as a bio-polyol component (A), being a polymerized product of a diol component (a) being a multifunctional alcohol component and containing a plant-derived component and a dicarboxylic acid component (b) being a multifunctional carboxylic acid component and containing a plant-derived component; an isocyanate component (B), which will be described later; and a polyamine component (C), which will be described later, used as necessary, and is constituted in such a way that the proportion (degree of biomass) of the plant-derived components in the resin is 35% by mass or more, and, further, 40% by mass or more. Hereinafter, the above-described bio-polyester polyol is referred to as a bio-polyol component (A). Therefore, it is desirable that a large amount of the multifunctional carboxylic acid component and the multifunctional alcohol component each being a raw material be derived from a plant. According to studies conducted by the present inventors, it has been found that for example, in addition to, needless to say, bio-succinic acid essential as the dicarboxylic acid component (b), also with respect to the additional dicarboxylic acid to be used together with bio-succinic acid, a plant-derived dicarboxylic acid is used as much as possible to make the constitution such that the ratio of use of the multifunctional alcohol component selected as the diol component (a) and selected from the plant-derived components is increased, and thereby when a printing ink is made applying a resultant polyurethane resin to a binder, the balance among pigment dispersibility, printability, and an adhesion property to a film base material in the printing ink is made favorable. In addition, according to more detailed studies, the printing ink obtained in the manner as described above is an industrially useful printing ink having excellent compatibility with conventional printing inks which have been used earlier in a printing apparatus, and capable of reducing the load on washing inside the printing apparatus, which brings about a problem when printing inks are changed in the process of printing operation.

(Petroleum-Derived Raw Material)

As described previously, to obtain a printing ink satisfying the “Biomass Mark” certification criterion, the printing intended as an object of the present invention, there is a need to make the proportion of the plant-derived components in the polyurethane resin for use as a binder in the ink 35% by mass or more, and, further, 40% by mass or more, as specified in the present invention. Therefore, the necessity arises that the plant-derived components as described previously are contained in a high proportion of use in the raw material components for the bio-polyol component (A) constituting the present invention. However, as described previously, in the raw material components for the bio-polyol component (A), the petroleum-derived raw materials as described below can be used together including the specific components specified in the present invention within a range where the intended purposes of the present invention are not impeded.

Examples of the petroleum-derived, multifunctional alcohol that can be used in the present invention include compounds having two or more, preferably 2 to 8 hydroxyl groups in one molecule. Specifically, for example, ethylene glycol, diethylene glycol, triethylene glycol, propylene glycol, 1,3-propanediol, 1,3-butanediol, 2-methyl-1,3-propanediol, dipropylene glycol, 1,6-hexanediol, neopentyl glycol, 1, 4-butanediol, 1,4-cyclohexane dimethanol, trimethylolpropane, glycerin, 1,9-nonanediol, 3-methyl-1,5-pentanediol, and the like each derived from a petroleum-derived component can be used together within a range where the intended purposes of the present invention are not impeded. These can be used singly or in combinations of two or more thereof.

Examples of the petroleum-derived, multifunctional carboxylic acid that can be used in the present invention include succinic acid, adipic acid, dodecanedioic acid, isophthalic acid, terephthalic acid, naphthalene dicarboxylic acid, phthalic acid, trimellitic acid, and pyromellitic acid, and these can also be used together within a range where the intended purposes of the present invention are not impeded.

In addition, in the bio-polyurethane resin according to the present invention, in addition to the bio-polyol component (A) as described previously, a petroleum-derived polyester polyol, a petroleum-derived polyether polyol, or the like can also be used together within a range where the intended purposes of the present invention are no impeded as long as the degree of biomass, which is specified in the present invention, of the resin to be finally obtained can be achieved. Specifically, for example, polyoxyethylene glycol, polyoxypropylene glycol, polyoxyethylene polyoxypropylene glycol, polyoxytetramethylene glycol, polycaprolactonediol, polymethyl valerolactone diol, polycarbonate diol, polybutadiene diol, and the like each derived from petroleum can appropriately be used.

As described previously, the present invention finally aims to develop a binder material that enables providing a non-toluene solvent-based or non-toluene, non-MEK solvent-based, high-performance printing ink and has a high degree of biomass. As a polyester polyol for a polyurethane resin that is generally considered to be useful as a vehicle for a conventional, non-toluene solvent-based or non-toluene, non-MEK-based ink, adipate polyesters, such as 2-methyl-1,3-propanediol, neopentyl glycol, and 3-methyl-1,5-pentanediol each being a petroleum-derived component, are known. Accordingly, the bio-polyurethane resin according to the present invention in particular, constituted in such a way that these adipate polyesters are utilized, and these adipate polyesters and the bio-polyol component (A) specified in the present invention are used and co-polymerized, is useful as a vehicle for a biomass printing ink that enables achieving the object of the present invention of realizing a non-toluene solvent-based or non-toluene, non-MEK-based printing ink, and besides, enables adjusting the degree of biomass from the viewpoint of costs in consideration of the practical problem that the prices of bio-component raw materials are generally high.

In the case where the petroleum-derived component as described above is utilized, when, as raw materials for the bio-polyol component (A) specified in the present invention, a dimer acid obtained from a plant-derived component is used as the multifunctional carboxylic acid component together with succinic acid obtained from a plant-derived component, and 1,2-propanediol or 1,3-propanediol obtained from a plant-derived component is used as the multifunctional alcohol component, the composition of the raw materials needs to be adjusted so that the proportion of the plant-derived components to be introduced in the polyurethane resin to be finally obtained will be 35% or more, and more preferably 40% or more. Such constitution makes a pigment-dispersed ink, when prepared using an obtained polyurethane resin, into a biomass ink product achieving the intended degree of biomass and having excellent printing properties. That is, the printing ink using as a vehicle the polyurethane resin solution constituted in the manner as described above is a non-toluene solvent-based or non-toluene, non-MEK solvent-based, high-performance printing ink satisfying the “Biomass Mark” certification criterion and having favorable balance among dispersion stability of a pigment in the ink, printability, and an adhesion property to a film base material.

(Additional Component: Low-Molecular-Weight Diol)

The polyester-based bio-polyurethane resin according to the present invention is obtained by polymerizing the above described bio-polyol component (A), isocyanate component (B) such as an organic diisocyanate, and polyamine component (C) used as necessary. According to studies conducted by the present inventors, a plant-derived or petroleum-derived low-molecular-weight diol can also be used together with the bio-polyol component (A) obtained from the raw material components described above for the purpose of adjusting the hydroxyl value of the component (A) and adjusting the physical properties, which are associated with the adjustment of the hydroxyl value, of the polyurethane resin to be finally obtained. Examples of the low-molecular-weight diol used in this case include ethylene glycol, diethylene glycol, triethylene glycol, propylene glycol, 1,3-proopanediol, 1,3-butanediol, 2-methyl-1,3-propanediol, dipropylene glycol, 1,6-hexanediol, neopentyl glycol, 1,4-butanediol, 1,4-cyclohexanedimethanol, trimethylolpropane, glycerin, 1,9-nonanediol, and 3-methyl-1,5-pentanediol.

[Isocyanate Component (B)]

A compound derived from a known diisocyanate can be used as the isocyanate component (B) constituting the present invention. Specific examples thereof include aliphatic diisocyanates such as hexamethylene diisocyanate, butane-1,4-diisocyanate, 2,2,4-trimethylhexamethylene diisocyanate, 2,4,4-trimethylhexamethylene diisocyanate, xylylene diisocyanate, and m-tetramethylxylylene diisocyanate. In addition, specific examples thereof include alicyclic diisocyanates such as isophorone diisocyanate, cyclohexane-1,4-diisocyanate, lysine diisocyanate, dicyclohexylmethane-4,4′-diisocyanate, 1,3-bis(isocyanate methyl) cyclohexane, methylcyclohexane diisocyanate, 4,4′-dicyclohexylmethane diisocyanate, isopropylidene dicyclohexyl-4,4′-diisocyanate, and norbornane diisocyanate. Further, specific examples thereof include aromatic diisocyanates such as 1,5-naphthylene diisocyanate, 4,4′-diphenylmethane diisocyanate, 4,4′-diphenyldimethylmethane diisocyanate, 4,4′-dibenzyl diisocyanate, a dialkyl diphenylmethane diisocyanate, a tetraalkyl diphenylmethane diisocyanate, 1,3-phenylene diisocyanate, 1,4-phenylene diisocyanate, tolylene diisocyanate, and tetramethylxylylene diisocyanate.

Besides, modified products, such as a biuret-modified product, an allophanate-modified product, an isocyanurate-modified product, and a carbodiimide-modified product, of the above-described polyisocyanate; adduct products obtained by reacting the above-described polyisocyanate and a polyol; and the like can also be used. Among those described above, isophorone diisocyanate, hexamethylene diisocyanate, 4,4′-dicyclohexylmethane diisocyanate, tolylene diisocyanate, and 4,4′ -diphenylmethane diisocyanate are preferable from the comprehensive viewpoint of reactivity/physical properties, and the like. These can be used singly or in combinations of two or more thereof.

In addition, using a plant-derived diisocyanate besides those described above as the isocyanate component (B) in order to achieve a high degree of biomass specified in the present invention is also a preferred embodiment of the bio-polyurethane resin according to the present invention. The plant-derived diisocyanate is obtained in such a way that a plant-derived, divalent carboxylic acid is subjected to acid-amidation and then reduction to be converted into a terminal amino group, and further, reacting a resultant product with phosgene to convert the amino group into an isocyanate group. The plant-derived diisocyanate includes dimer acid diisocyanate (DDI), octamethylene diisocyanate, decamethylene diisocyanate, and the like. In addition, a plant-derived isocyanate compound can also be obtained by using a plant-derived amino acid as a raw material and converting the amino group into an isocyanate group. For example, lysine diisocyanate (LDI) is obtained by methyl-esterifying a carboxyl group of lysine and then converting an amino group into an isocyanate group. In addition, 1,5-pentamethylene diisocyanate is obtained by decarbonating a carboxyl group of lysine and then converting an amino group into an isocyanate group.

[Polyamine Component (C)]

The polyamine that constitutes the present invention and is used in the reaction as necessary is not particularly limited, but a diamine as described below is preferably used. As the diamine, known aliphatic, alicyclic, and aromatic diamines can be used. Examples thereof include diamines, such as ethylenediamine, propylenediamine, butylenediamine, hexamethylenediamine, trimethylhexamethylenediamine, isophoronediamine, cyclohexyldiamine, piperazine, 2-methylpiperazine, phenylenediamine, tolylenediamine, xylenediamine, 1,3-cyclohexyldiamine, 4,4′-diaminodicyclohexylamine, m-xylylenediamine, 2-hydroxyethylethylenediamine, 2-hydroxyethylpropylenediamine, di-2-hydroxyethylpropylenediamine, di-2-hydroxypropylethylenediamine, and a polyoxyalkylene diamine, and a hydrogenated product thereof, or mixtures thereof. Besides, to achieve a high degree of biomass, which is specified in the present invention, of the bio-polyurethane resin, diamines obtained from a plant-derived component, such as cellulose-derived 1,5-pentanediamine, and plant-based oil and fat-derived 1,10-decanediamine and dimer diamine, can also be used in a range where the intended purposes of the present invention are not impeded.

In addition, a monoamine as a reaction terminator can be used as necessary together with the above-described polyamine. Examples of the monoamine include mono-n-butylamine, di-n-butylamine, monoethanolamine, and diethanolamine.

The polyurethane resin which is obtained when the polyamine component (C) as described above is used as a reaction component and which has a urethane urea bond in the structure thereof is more preferably the one having an active amino group at a terminal thereof. Adjustment of the concentration of the terminal active amino group in this case is determined by the blending ratio of the urethane prepolymer having a terminal isocyanate group derived from the organic diisocyanate as exemplified previously, the polyamine functioning as a chain extender, preferably the diamine, and the monoamine functioning as a reaction terminator. As described previously, the “active amino group” in the present invention refers to a primary or secondary amino group having active hydrogen. According to studies conducted by the present inventors, the concentration of this active amino group is preferably 15 to 100μ equivalent per 1 g of the solid content of the resin in considering the case where the resin is applied to a binder in a printing ink. That is, it is not preferable that the concentration of the active amino group is less than 15μ equivalent per 1 g of the solid content of the resin because when printing is carried out on a recording medium composed of treated polypropylene, a polyester film, or the like, the adhesion property to these recording media is poor. On the other hand, it is not preferable that the concentration of the active amino group exceeds 100μ equivalent because when a isocyanate hardener is blended to make an embodiment of two liquid inks, the pot life of the blended liquid at the time of use is shortened, thereby causing a problem in usable time.

[Organic Solvent]

Further, the bio-polyurethane resin according to the present invention, when used as, for example, a binder in a printing ink, is preferably made into the form of a solution containing an organic solvent. That is, the organic solvent is used in synthesis of the resin or dilution for adjusting the concentration. When the bio-polyurethane resin according to the present invention is made into the form of a solution, an aspect is preferably made such that the bio-polyurethane resin according to the present invention is dissolved favorably in the organic solvent used, and the organic solvent does not contain toluene or does not contain any of toluene and MEK. As the organic solvent to be used, any of known organic solvents can be used as long as it dissolves the bio-polyurethane resin according to the present invention. In addition, from the viewpoint of dealing with the environmental problems, such as a bad odor and safety, an embodiment not containing toluene or not containing toluene and MEK is desirably made. When a solvent is made to be non-toluene-based, for example, a mixed solvent of ester-based solvent/alcohol-based solvent/ketone-based solvent is suitably used, and when a solvent is made to be non-toluene, non-MEK-based, a mixed solvent of ester-based solvent/alcohol-based solvent is suitably used.

Examples of the ester-based solvent include ethyl acetate, n-propyl acetate, isopropyl acetate, n-butyl acetate, and isobutyl acetate. A particularly preferred solvent in the present invention is ethyl acetate.

Examples of the alcohol-based solvent include methyl alcohol, ethyl alcohol, isopropyl alcohol, n-butyl alcohol, and tertiary butyl alcohol. A particularly preferred solvent in the present invention is isopropyl alcohol.

Examples of the ketone-based solvent include acetone, methyl ethyl ketone (MEK), and diisobutyl ketone. A particularly preferred solvent is MEK. When high-speed printability is thought to be important, using MEK is advantageous. On the other hand, a non-toluene, non-MEK-based printing ink in consideration of air pollutants represented by Regulation of Hazardous Air Pollutants (HAPS) is set as a target composition, production is carried out without using toluene and MEK.

In addition, in the case where the bio-polyurethane resin according to the present invention is made into the form of a solution, when, as an organic solvent, a plant-derived organic solvent is used for, for example, a binder in a printing ink, the plant-derived organic solvent can be contained in a range where the performance of the printing ink is not influenced. For example, as an organic solvent for use in the synthesis of the bio-polyurethane resin, the use of an organic solvent containing a plant-derived one (for example, ethyl acetate, butyl acetate, ethyl lactate, butyl lactate, or ethyl alcohol) as a part thereof makes a material into the one considering reduction in the amount of CO₂ to be discharged with respect to not only the constituents of the resin but also solvent components.

[Polyurethane Resin Solution]

The use of the raw materials containing the polyamine component (C) previously described as the reaction component can make the polyester-based polyurethane resin according to the present invention having achieved a high degree of biomass, having a urethane urea bond in the structure thereof, and having an active amino group at a terminal thereof. As described previously, more preferred embodiment in this case is to make a resin solution of the polyester-based polyurethane resin having an active amino group concentration of 15 to 100μ equivalent per 1 g of the solid content of the resin and having an active amino group at a terminal thereof, the resin solution containing an ester-based solvent, and an alcohol-based solvent and/or a ketone-based solvent. Such constitution makes a polyurethane resin solution suitable for dispersing a pigment, exhibiting a high degree of biomass as high as having a proportion of the plant-derived components in the solid content of the resin of 35% by mass or more, and, further, 40% by mass or more, and having plant-derived components. The use of the polyurethane resin solution according to the present invention having such constitution, as varnish for dispersing a pigment, for ink application enables realizing a printing ink having a high degree of biomass and having excellent dispersion stability of a pigment, adhesion property to a base material film where printing is to be carried out, printability, and the like.

[Method for Producing Polyurethane Resin Solution]

The solution of the polyurethane resin according to the present invention synthesized using plant-derived raw materials and having an active amino group at a terminal thereof can be produced in the manner as described below. The polyurethane resin solution according to the present invention is obtained, for example, in such a way that a urethane prepolymer having an isocyanate at both terminals thereof, the urethane prepolymer obtained from and by reacting: the bio-polyol component (A) obtained from the previously described raw materials; the additional material, such as a petroleum-derived polyol or a short-chain diol, which is used as necessary; and the organic diisocyanate of the (B) component in an excessive amount to those materials, is put into an excessive amount of a solution of the polyamine component (C) (diamine in particular) (hereinafter, sometimes referred to as diamine solution), and a resultant mixture is stirred and mixed to perform chain extension. The previously described organic solvent may be used for the diamine solution. It is to be noted that when adjusting the concentration of the active amino group at the terminal of the polyurethane resin, or the like is needed, a monoamine as a terminator is preferably blended in the diamine solution and used. In addition, a reaction catalyst composed of a metal catalyst or an amine salt can be used as necessary at the time of producing the above-described urethane prepolymer having an isocyanate at both terminals.

<Printing Ink>

The printing ink according to the present invention is characterized in that it contains: a pigment; and a binder for a printing ink, wherein the polyurethane resin solution according to the present invention is used as a binder for a printing ink in an amount such that the proportion of the plant-derived components in the solid content of the ink is 10% by mass or more. Specifically, a printing ink having plant-derived components and having achieved a high degree of biomass is obtained by dispersing the polyurethane resin solution according to the present invention, obtained in the manner as described above, a pigment, and an organic solvent for dilution using any of various types of known dispersers. As the organic solvent for dilution, an ester-based solvent and an alcohol-based solvent and/or a ketone-based solvent, more suitably, a solvent not containing toluene or not containing toluene and MEK is preferably used as described previously. In addition, in the printing ink according to the present invention, a pigment dispersant, an anti-blocking agent, an anti-foaming agent, a levelling agent, a coupling agent such as a silane-based or titanate-based coupling agent, a plasticizer, water, a slow-drying solvent for controlling drying, a viscosity stabilizer such as an organic acid, an ultraviolet absorber, an antioxidant, and the can also be added as necessary.

Further, in the printing ink, nitrocellulose, chlorinated polyethylene, chlorinated polypropylene, a vinyl chloride/vinyl acetate copolymer, a maleic acid resin, a polyvinyl butyral resin, a cellulose-based resin, and the like can also be used together.

The printing ink according to the present invention prepared in the manner as described above can be applied to various printing methods. Specifically, the printing ink according to the present invention can be used for gravure printing, flexographic printing, screen printing, offset printing, or inkjet printing. The printing ink according to the present invention is particularly suitable for gravure printing.

Further, the printing ink according to the present invention having the above-described constitution can be applied to various base materials, and for example, favorable printing can be carried out on various biomass plastic films obtained from a plant-derived material, plant-derived paper, and the like. The printing ink according to the present invention can be widely used for various applications, particularly, such as a film package or a paper package for food packaging, a building material, or tissue paper.

### EXAMPLES

Next, the present invention will be described more specifically giving Examples and Comparative Examples. It is to be noted that “parts” or “%” below is on a mass basis unless otherwise noted.

[Preparation of Polyurethane Resin Solution]

### Example 1

Firstly, a polyester polyol was prepared in the manner as described below. As a multifunctional carboxylic acid component (hereinafter, referred to as dicarboxylic acid component), dimer acid (dimer purity of 98%) obtained from a plant-derived component/succinic acid obtained from a plant-derived component=90/10 (molar ratio) was used, and as a multifunctional alcohol component (hereinafter, referred to as diol component), 1,3-propanediol obtained from a plant-derived component was used. These components were each used in an appropriate amount so as to obtain a target molecular weight and polymerized to obtain a polyester diol PE (1) 100% obtained from plant-derived components, the PE (1) having a hydroxyl value of 37.3 mgKOH/g, an acid value of 0.3 mgKOH/g, and a number average molecular weight of 3000, as shown in Table 1-1.

Next, 500 parts of the polyester diol PE (1) obtained above and 66.4 parts of isophorone diisocyanate (hereinafter, abbreviated as IPDI), which is an organic diisocyanate, were loaded in a reaction container and reacted at 100° C. for 5 hours in a nitrogen gas stream to obtain a urethane prepolymer having an NCO group content of 1.87% as shown in Table 2-1. The obtained urethane prepolymer was dissolved in 188.8 parts of ethyl acetate, which is an organic solvent for dilution, to make a urethane prepolymer solution (1) having a non-volatile content of 75%.

Subsequently, a mixture (diamine solution) of 23.6 parts of isophorone diamine (hereinafter, abbreviated as IPDA), which is a polyamine, 981.4 parts of ethyl acetate, and 206.5 parts of isopropyl alcohol (hereinafter, abbreviated as IPA) was blended, 755.2 parts of the urethane prepolymer solution (1) obtained previously was dropped in the mixture under stirring, and a resultant mixture was reacted at 40° C. for 1 hour. As a result, a polyurethane resin solution PU1 of the present Example having a non-volatile content (solid content) of 30%, a viscosity of 1150 mPa·s (25° C.), a terminal amino group concentration of 42.8μ equivalent per 1 g of the solid content of the resin, and 84.7% of plant-derived components in the solid content of the resin was obtained. Table 2-1 shows the combination and characteristics of the polyurethane resin solution PU1 obtained above.

### Example 2

A polyurethane resin solution was prepared basically in the same manner as in Example 1. As a dicarboxylic acid component, dimer acid (dimer purity of 98%) obtained from a plant-derived component/succinic acid obtained from a plant-derived component=60/40 (molar ratio) was used, and as a diol component, 1,3-propanediol obtained from a plant-derived component was used. These components were each used in an appropriate amount and polymerized to obtain a polyester diol PE (2) 100% obtained from plant-derived components, the PE (2) having a hydroxyl value of 56.0 mgKOH/g, an acid value of 0.3 mgKOH/g, and a number average molecular weight of 2000, as shown in Table 1-1.

Next, 500 parts of the polyester diol PE (2) obtained above and 88.6 parts of IPDI were loaded in a reaction container and reacted at 100° C. for 5 hours in a nitrogen gas stream to obtain a urethane prepolymer having an NCO group content of 2.03% as shown in Table 2-1. The obtained urethane prepolymer was dissolved in 196.2 parts of ethyl acetate to make a urethane prepolymer solution (2) having a non-volatile content of 75%.

Subsequently, a mixture of 26.6 parts of IPDA, 1024.0 parts of ethyl acetate, and 215.3 parts of IPA was blended, 784.9 parts of the urethane prepolymer solution (2) obtained above was dropped in the mixture under stirring, and a resultant mixture was reacted at 40° C. for 1 hour. As a result, a polyurethane resin solution PU2 of the present Example having a non-volatile content of 30%, a viscosity of 1020 mPa·s (25° C.), a terminal amino group concentration of 46.2μ equivalent per 1 g of the solid content of the resin, and 81.3% of plant-derived components in the solid content of the resin was obtained. Table 2-1 shows the combination and characteristics of the polyurethane resin solution PU2 obtained above.

### Example 3

A polyurethane resin solution was prepared basically in the same manner as in Example 1. As a dicarboxylic acid component, dimer acid (dimer purity of 98%) obtained from a plant-derived component/succinic acid obtained from a plant-derived component=2/98 (molar ratio) was used, and as a diol component, 1,3-propanediol obtained from a plant-derived component was used. These components were each used in an appropriate amount and polymerized to obtain a polyester diol PE (3) having 100% of plant-derived components, the PE (3) having a hydroxyl value of 37.3 mgKOH/g, an acid value of 0.3 mgKOH/g, and a number average molecular weight of 3000, as shown in Table 1-1.

Next, 500 parts of the polyester diol PE (3) obtained above and 59.0 parts of IPDI were loaded in a reaction container and reacted at 100° C. for 5 hours in a nitrogen gas stream to obtain a urethane prepolymer having an NCO group content of 1.42% as shown in Table 2-1. The obtained urethane prepolymer was dissolved in 186.4 parts of ethyl acetate to make a urethane prepolymer solution (3) having a non-volatile content of 75%.

Subsequently, a mixture of 18.2 parts of IPDA, 958.5 parts of ethyl acetate, and 202.0 parts of IPA was blended, 745.4 parts of the urethane prepolymer solution (3) obtained above was dropped in the mixture under stirring, and a resultant mixture was reacted at 40° C. for 1 hour. As a result, a polyurethane resin solution PU3 of the present Example having a non-volatile content of 30%, a viscosity of 1100 mPa·s (25° C.) a terminal amino group concentration of 42.7μ equivalent per 1 g of the solid content of the resin, and 86.6% of plant-derived components in the solid content of the resin was obtained. Table 2-1 shows the combination and characteristics of the polyurethane resin solution PU3 obtained above.

### Example 4

Firstly, a polyester polyol was prepared in the manner as described below. As a dicarboxylic acid component, petroleum-derived adipic acid, and as a diol component, petroleum-derived neopentyl glycol/1,4-butanediol=70/30 (molar ratio) were used. These components were each used in an appropriate amount and polymerized to obtain a polyester diol PE (4) 100% obtained from petroleum-derived components, the PE (4) having a hydroxyl value of 37.3 mgKOH/g, an acid value of 0.3 mgKOH/g, and a number average molecular weight of 3000, as shown in Table 1-1.

Next, 250 parts of the polyester diol PE (4) obtained above, 250 parts of the polyester diol PE (2) obtained in Example 2 and 100% obtained from plant-derived components, and 73.8 parts of IPDI were loaded in a reaction container and reacted at 100° C. for 5 hours in a nitrogen gas stream to obtain a urethane prepolymer having an NCO group content of 1.73% as shown in Table 2-1. The obtained urethane prepolymer was dissolved in 191.3 parts of ethyl acetate to make a urethane prepolymer solution (4) having a non-volatile content of 75%.

Subsequently, a mixture of 22.4 parts of IPDA, 504.3 parts of ethyl acetate, 208.7 parts of IPA, and 486.9 parts of MEK was blended, 765.1 parts of the urethane prepolymer solution (4) obtained previously was dropped in the mixture under stirring, and a resultant mixture was reacted at 40° C. for 1 hour. As a result, a polyurethane resin solution PU4 of the present Example having a non-volatile content of 30%, a viscosity of 1050 mPa·s (25° C.), a terminal amino group concentration of 43.7μ equivalent per 1 g of the solid content of the resin, and 41.9% of plant-derived components in the solid content of the resin was obtained. Table 2-1 shows the combination and characteristics of the polyurethane resin solution PU4 obtained above.

### Example 5

Firstly, a polyester polyol was prepared in the manner as described below. As a dicarboxylic acid component, dimer acid (dimer purity of 98%) obtained from a plant-derived component/succinic acid obtained from a plant-derived component/adipic acid obtained from a petroleum-based and -derived component=10/30/60 (molar ratio) “note: additional dicarboxylic acid/plant-derived succinic acid=70/30 and dimer acid/plant-derived succinic acid=10/30=25/75 (molar ratio)”, and as a diol component, 1,3-propane diol obtained from plant-derived component/neopentyl glycol obtained from a petroleum-based and -derived component=30/70 (molar ratio) were used. These components were each used in an appropriate amount and polymerized to obtain a polyester diol PE (5) having 41.2% of plant-derived components, the PE (5) having a hydroxyl value of 30.2 mgKOH/g, an acid value of 0.3 mgKOH/g, and a number average molecular weight of 3710, as shown in Table 1-1.

Next, 500 parts of the polyester diol PE (5) obtained above and 47.8 parts of IPDI were loaded in a reaction container and reacted at 100° C. for 5 hours in a nitrogen gas stream to obtain a urethane prepolymer having an NCO group content of 1.18% as shown in Table 2-1. The obtained urethane prepolymer was dissolved in 182.0 parts of ethyl acetate, which is an organic solvent for dilution, to make a urethane prepolymer solution (5) having a non-volatile content of 75%.

Subsequently, a mixture of 14.7 parts of IPDA, 933.6 parts of ethyl acetate, and 197.0 parts of IPA was blended, 730.4 parts of the urethane prepolymer solution (5) obtained above was dropped in the mixture under stirring, and a resultant mixture was reacted at 40° C. for 1 hour. As a result, a polyurethane resin solution PU5 of the present Example having a non-volatile content of 30%, a viscosity of 1200 mPa·s (25° C.) a terminal amino group concentration of 40.9μ equivalent per 1 g of the solid content of the resin, and 36.6% of plant-derived components in the solid content of the resin was obtained. Table 2-1 shows the combination and characteristics of the polyurethane resin solution PU5 obtained above.

### Examples 6 to 13

Polyester polyols PE (6) to PE (12) were each prepared using raw materials for synthesis shown in Table 1-2 in the same manner as in Example 1. Table 1-2 shows the hydroxyl value, acid value, number average molecular weight, and plant-derived component ratio of each of the prepared polyester diols PE (6) to PE (12).

Next, each of the polyester diols PE (6) to PE (12) obtained above and IPDI were reacted in a reaction container according to the combination shown in Table 2-2 in the same manner as in Example 1 to obtain each urethane prepolymer. Table 2-1 shows the NCO % of each urethane prepolymer. Each of the urethane prepolymers obtained above was dissolved in a predetermined amount of ethyl acetate to make urethane prepolymer solutions (6) to (13) each having a non-volatile content of 75%.

Subsequently, a mixture of IPDA, ethyl acetate, and IPA was blended in a mass ratio shown in Table 2-2, the whole amount of the urethane prepolymer solution obtained above was dropped in the mixture under stirring, and a resultant mixture was reacted at 40° C. for 1 hour. As a result, polyurethane resin solutions PU6 to PU13 of the present Examples were each obtained. Table 2-2 shows the combination and characteristics of each of the polyurethane resin solutions PU6 to PU13 obtained above together. It is to be noted that as shown in Table 2-2, the polyurethane resin solution PU13 as well as the polyurethane resin solution PU6 uses the polyester diol PE (6) as a raw material, but the amino group equivalent is considerably different from that of the polyurethane resin solution PU6 as a result of changing the amount of IPDI and the amount of IPDA used from those in the case of producing the polyurethane resin solution PU6.

TABLE 1-1
Raw material compositions and characteristics of polyester diols used in Examples and Comparative Examples

| Polyester diol No. | | PE (1) | PE (2) | PE (3) | PE (4) | PE (5) |
|---|---|---|---|---|---|---|
| Dicarboxylic acid | Adipic acid | | | | 100 | 60 |
| component | Bio-succinic acid | 10 | 40 | 98 | | 30 |
| (molar ratio) | Bio-dimer acid | 90 | 60 | 2 | | 10 |
| | Bio-sebacic acid | | | | | |
| Diol | NPG | | | | 70 | 70 |
| component | 1,4-BD | | | | 30 | |
| (molar ratio) | Bio-EG | | | | | |
| | Bio-1,4-BD | | | | | |
| | Bio-1,2-PD | | | | | |
| | Bio-1,3-PD | 100 | 100 | 100 | | 30 |

| | | | | | |
|---|---|---|---|---|---|
| Hydroxyl value (mgKOH/g) | 37.3 | 56.0 | 37.3 | 37.3 | 30.2 |
| Acid value (mgKOH/g) | 0.3 | 0.3 | 0.3 | 0.3 | 0.3 |
| Number average molecular weight | 3000 | 2000 | 3000 | 3000 | 3710 |
| Bio % | 100 | 100 | 100 | 0 | 41.2 |

TABLE 1-2
Raw material compositions and characteristics of polyester diols used in
Examples and Comparative Examples

| | | PE | PE | PE | PE | PE | PE | PE |
|---|---|---|---|---|---|---|---|---|
| Polyester diol No. | | (6) | (7) | (8) | (9) | (10) | (11) | (12) |
| Dicarboxylic acid | Adipic acid | | | | 60 | 60 | 20 | 60 |
| component | Bio-succinic acid | 40 | 40 | 40 | 40 | 40 | 80 | |
| (molar ratio) | Bio-dimer acid | 60 | 60 | 60 | | | | |
| | Bio-sebacic acid | | | | | | | 40 |
| Diol | NPG | | | | | 30 | 70 | 30 |
| component | 1,4-BD | | | | | | | |
| (molar ratio) | Bio-EG | 30 | | | | | | |
| | Bio-1,4-BD | | 30 | | | | | |
| | Bio-1,2-PD | | | 30 | 100 | 70 | 30 | |
| | Bio-1,3-PD | 70 | 70 | 70 | | | | 70 |

| | | | | | | | |
|---|---|---|---|---|---|---|---|
| Hydroxyl value (mgKOH/g) | 37.4 | 37.4 | 37.4 | 37.4 | 37.4 | 37.4 | 37.4 |
| Acid value (mgKOH/g) | 0.3 | 0.3 | 0.3 | 0.3 | 0.3 | 0.3 | 0.3 |
| Number average molecular weight | 3000 | 3000 | 3000 | 3000 | 3000 | 3000 | 3000 |
| Bio % | 100 | 100 | 100 | 62.5 | 47.1 | 47.8 | 55.2 |

The abbreviations in Table 1-1 and Table 1-2 are as described below.

NPG: Neopentyl glycol

EG: Ethylene glycol

1,4-BD: 1,4-Butanediol

1,2-PD: 1,2-Propanediol

1,3-PD: 1,3-Propanediol

TABLE 2-1
Combinations and characteristics of bio-polyurethane resin
solutions of Examples

| | | Example | | | | |
|---|---|---|---|---|---|---|
| Polyurethane resin | | 1 | 2 | 3 | 4 | 5 |
| solution No. | | PU1 | PU2 | PU3 | PU4 | PU5 |
| Urethane | No. | (1) | (2) | (3) | (4) | (5) |
| prepolymer | PE (1) | 500 | | | | |
| solution | PE (2) | | 500 | | 250 | |
| | PE (3) | | | 500 | | |
| | PE (4) | | | | 250 | |
| | PE (5) | | | | | 500 |
| | IPDI | 66.4 | 88.6 | 59.0 | 73.8 | 47.8 |
| | NCO % | 1.87 | 2.03 | 1.42 | 1.73 | 1.18 |
| | Ethyl acetate | 188.8 | 196.2 | 186.4 | 191.3 | 182.0 |

| | | | | | |
|---|---|---|---|---|---|
| IPDA | 23.6 | 26.6 | 18.2 | 22.4 | 14.7 |
| Ethyl acetate | 981.4 | 1024.0 | 958.5 | 504.3 | 933.6 |
| IPA | 206.5 | 215.3 | 202.0 | 208.7 | 197.0 |
| MEK | | | | 486.9 | |
| Solid content (%) | 30 | 30 | 30 | 30 | 30 |
| Viscosity/mPas (25° C.) | 1150 | 1020 | 1100 | 1050 | 1200 |
| Amino group equivalent | 42.8 | 46.2 | 42.7 | 43.7 | 40.9 |
| (μeq/g) | | | | | |
| Bio % | 84.7 | 81.3 | 86.6 | 41.9 | 36.6 |

TABLE 2-2
Combinations and characteristics of bio-polyurethane resin solutions of
Examples

| | | Example | | | | | | | |
|---|---|---|---|---|---|---|---|---|---|
| Polyurethane resin | | 6 | 7 | 8 | 9 | 10 | 11 | 12 | 13 |
| solution No. | | PU6 | PU7 | PU8 | PU9 | PU10 | PU11 | PU12 | PU13 |
| Urethane | No. | (6) | (7) | (8) | (9) | (10) | (11) | (12) | (13) |
| prepolymer solution | PE (6) | 500 | | | | | | | 500 |
| | PE (7) | | 500 | | | | | | |
| | PE (8) | | | 500 | | | | | |
| | PE (9) | | | | 500 | | | | |
| | PE (10) | | | | | 500 | | | |
| | PE (11) | | | | | | 500 | | |
| | PE (12) | | | | | | | 500 | |
| | IPDI | 66.6 | 66.6 | 66.6 | 66.6 | 59.2 | 66.6 | 66.6 | 64.8 |
| | NCO % | 1.87 | 1.87 | 1.87 | 1.87 | 1.41 | 1.87 | 1.87 | 1.77 |
| | Ethyl acetate | 188.9 | 188.9 | 189.9 | 189.9 | 186.4 | 189.9 | 189.9 | 188.3 |

| | | | | | | | | |
|---|---|---|---|---|---|---|---|---|
| IPDA | 23.5 | 23.5 | 23.5 | 23.5 | 18.0 | 23.5 | 23.5 | 21.3 |
| Ethyl acetate | 981.1 | 981.1 | 981.1 | 981.1 | 958.6 | 981.1 | 981.1 | 973.7 |
| IPA | 206.5 | 206.5 | 206.5 | 206.5 | 202.0 | 206.5 | 206.5 | 205.1 |
| Solid content (%) | 30 | 30 | 30 | 30 | 30 | 30 | 30 | 30 |
| Viscosity/mPas | 1180 | 1180 | 1180 | 1200 | 1200 | 1200 | 1210 | 1400 |
| (25° C.) | | | | | | | | |
| Amino group | 41.0 | 41.0 | 41.0 | 41.0 | 41.6 | 41.0 | 41.0 | 21.4 |
| equivalent (μeq/g) | | | | | | | | |
| Bio % | 84.7 | 84.7 | 84.7 | 53.0 | 40.8 | 40.5 | 46.8 | 85.3 |

The abbreviations in Table 2-1 and Table 2-2 are as described below.

IPDI: Isophorone diisocyanate

IPDA: Isophorone diamine

IPA: Isopropyl alcohol

MEK: Methyl ethyl ketone

### Comparative Example 1

A polyurethane resin solution of the present Comparative Example was prepared in the same manner as in Example 1 except that succinic acid which is essential in the present invention and obtained from a plant-derived component was not used as a raw material in the polymerization for the polyester polyol. Firstly, as a dicarboxylic acid component, only a dimer acid (dimer purity of 98%) obtained from a plant-derived component was used, and as a diol component, 1,3-propanediol obtained from a plant-derived component was used. These components were used each in an appropriate amount and polymerized to obtain a polyester diol PE (13) 100% obtained from plant-derived components, the PE (13) having a hydroxyl value of 37.3 mgKOH/g, an acid value of 0.3 mgKOH/g, and a number average molecular weight of 3000, as shown in Table 3.

Next, 500 parts of the polyester diol PE (13) obtained above and 66.4 parts of IPDI were loaded in a reaction container and reacted at 100° C. for 5 hours in a nitrogen gas stream to obtain a urethane prepolymer having an NCO group content of 1.87% as shown in Table 4. The obtained urethane prepolymer was dissolved in 188.8 parts of ethyl acetate to make a urethane prepolymer comparative solution (C1) having a non-volatile content of 75%.

Subsequently, a mixture of 23.8 parts of IPDA, 981.9 parts of ethyl acetate, and 206.6 parts of IPA was blended, 755.2 parts of the urethane prepolymer comparative solution (C1) obtained above was dropped in the mixture under stirring, and a resultant mixture was reacted at 40° C. for 1 hour. As a result, a polyurethane resin solution PU-C1 of the present Comparative Example having a non-volatile content of 30%, a viscosity of 1090 mPa·s (25° C.), a terminal amino group concentration of 47.1μ equivalent per 1 g of the solid content of the resin, and 84.7% of plant-derived components in the solid content of the resin was obtained. Table 4 shows the combination and characteristics of the polyurethane resin solution PU-C1 obtained above.

### Comparative Example 2

A polyurethane resin solution of the present Comparative Example was prepared in the same manner as in Example 1 except that as a dicarboxylic acid component, only succinic acid obtained from a plant-derived component was used without using an additional dicarboxylic acid such as the dimer acid to make the dicarboxylic acid component 100% composed of succinic acid. Firstly, as a dicarboxylic acid component, only succinic acid obtained from a plant-derived component was used, and as a diol component, 1,3-propanediol obtained from a plant-derived component was used. These components were used each in an appropriate amount and polymerized to obtain a polyester diol PE (14) 100% obtained from plant-derived components, the PE (14) having a hydroxyl value of 37.3 mgKOH/g, an acid value of 0.3 mgKOH/g, and a number average molecular weight of 3000 as shown in Table 3.

Next, 500 parts of the polyester diol PE (14) obtained above and 62.7 parts of IPDI were loaded in a reaction container and reacted at 100° C. for 5 hours in a nitrogen gas stream to obtain a urethane prepolymer having an NCO group content of 1.65% as shown in Table 4. The obtained urethane prepolymer was dissolved in 187.6 parts of ethyl acetate to make a urethane prepolymer comparative solution (C2) having a non-volatile content of 75%.

Subsequently, a mixture of 20.9 parts of IPDA, 969.9 parts of ethyl acetate, and 204.3 parts of IPA was blended, 750.3 parts of the urethane prepolymer comparative solution (C2) obtained above was dropped in the mixture under stirring, and a resultant mixture was reacted at 40° C. for 1 hour. As a result, a polyurethane resin solution PU-C2 of the present Comparative Example having a non-volatile content of 30%, a viscosity of 1180 mPa·s (25° C.), a terminal amino group concentration of 41.7μ equivalent per 1 g of the solid content of the resin, and 85.7% of plant-derived components in the solid content of the resin was obtained. Table 4 shows the combination and characteristics of the polyurethane resin solution PU-C2 obtained above.

### Comparative Example 3

In a reaction container, 180 parts of the polyester diol PE (2) used in Example 2 and 100% obtained from plant-derived components, 320 parts of the polyester diol PE (4) used in Example 4 and 100% obtained from petroleum-derived components, and 59.0 parts of IPDI were loaded and reacted at 100° C. for 5 hours in a nitrogen gas stream to obtain a urethane prepolymer having an NCO group content of 1.42% as shown in Table 4. The obtained urethane prepolymer was dissolved in 186.4 parts of ethyl acetate to obtain a urethane prepolymer comparative solution (C3) in which large amounts of the petroleum-derived components were used, the urethane prepolymer comparative solution (C3) having a non-volatile content of 75%.

Subsequently, a mixture of 18.2 parts of IPDA, 958.5 parts of ethyl acetate, and 202.0 parts of IPA was blended, 745.4 parts of the urethane prepolymer comparative solution (C3) obtained above was dropped in the mixture under stirring, and a resultant mixture was reacted at 40° C. for 1 hour. As a result, a polyurethane resin solution PU-C3 of the present Comparative Example having a low degree of biomass, the PU-C3 having a non-volatile content of 30%, a viscosity of 1100 mPa·s (25° C.), a terminal amino group concentration of 42.7μ equivalent per 1 g of the solid content of the resin, and 31.2% of plant-derived components in the solid content of the resin was obtained. Table 4 shows the combination and characteristics of the polyurethane resin solution PU-C3 obtained above.

### Comparative Example 4

A polyurethane resin solution of the present Comparative Example was prepared basically in the same manner as in Examples except that succinic acid, which is essential in the present invention, and as a diol component, the components, such as 1,3-propane diol, which are specified in the present invention were not used in the preparation of a polyester polyol. It is to be noted that the resin of the present Comparative Example corresponds to the resin described in Production Example 9 of Patent Literature 1 previously described.

Firstly, as a dicarboxylic acid component, only a dimer acid (dimer purity of 98%) obtained from a plant-derived component, and as a diol component, 1,6-hexanediol obtained from a petroleum-derived component were used, and these components were each used in an appropriate amount and polymerized to obtain a polyester diol PE (15) having a hydroxyl value of 57.0 mgKOH/g, an acid value of 0.4 mgKOH/g, a number average molecular weight of 2000, and 81.1% of plant-derived components as shown in Table 3. In a reaction container, 500 parts of the obtained polyester diol PE (15) and 111.0 parts of IPDI were loaded and reacted at 100° C. for 5 hours in a nitrogen gas stream to obtain a urethane prepolymer having an NCO group content of 3.36% as shown in Table 4. The obtained urethane prepolymer was dissolved in 203.7 parts of ethyl acetate to obtain a urethane prepolymer comparative solution (C4) having a non-volatile content of 75%.

Subsequently, a mixture of 38.8 parts of IPDA, 1100.6 parts of ethyl acetate, and 230.2 parts of IPA was blended, 814.7 parts of the urethane prepolymer comparative solution (C4) obtained above was dropped in the mixture under stirring, and a resultant mixture was reacted at 40° C. for 1 hour. As a result, a polyurethane resin solution PU-C4 of the present Comparative Example having a non-volatile content of 30%, a viscosity of 1020 mPa·s (25° C.), a terminal amino group concentration of 42.5μ equivalent per 1 g of the solid content of the resin, and 61.6% of plant-derived components in the solid content of the resin was obtained. Table 4 shows the combination and characteristics of the polyurethane resin solution PU-C4 obtained above.

### Comparative Examples 5 to 8

The carboxylic acid components and the diol components shown in Table 3 were each used in an appropriate amount and polymerized in the same manner as in Example 1 to prepare a polyester diol PE (16) 100% obtained from petroleum-derived components and a polyester diol PE (17) 100% obtained from plant-derived components, the PE (16) and the PE (17) each having a hydroxyl value, an acid value, a number average molecular weight, and a plant-derived component ratio shown in Table 3.

Next, in a reaction container, the polyester diol PE (6) used previously in Example 6 and Example 13, and the polyester diol PE (16) and the polyester diol PE (17), which are obtained above, were each used with IPDI according to the combination in Table 4 and reacted in the same manner as in Examples to obtain each urethane prepolymer having an NCO % shown in Table 4. Obtained each urethane prepolymer was dissolved in a predetermined amount of ethyl acetate to obtain urethane prepolymer comparative solutions (C5) to (C8) each having a non-volatile content of 75%.

Subsequently, each mixture of IPDA, ethyl acetate, and IPA was blended in a mass ratio shown in Table 4, the whole amount of each urethane prepolymer solution obtained above was dropped in the mixture under stirring, and a resultant mixture was reacted at 40° C. for 1 hour. As a result, polyurethane resin solutions PU-05 to PU-C8 of Comparative Examples of 5 to 8 were each obtained. Table 4 shows the combinations and characteristics of the polyurethane resin solutions PU-05 to PU-C8 obtained above.

TABLE 3
Raw material compositions and characteristics of polyester diols used in Comparative Examples

| Polyester diol No. | | PE (13) | PE (14) | PE (15) | PE (16) | PE (17) |
|---|---|---|---|---|---|---|
| Dicarboxylic acid | Adipic acid | | | | 100 | |
| component | Bio-succinic acid | | 100 | | | |
| (molar ratio) | Bio-dimer acid | 100 | | 100 | | |
| | Bio-sebacic acid | | | | | 100 |
| Diol | NPG | | | | 50 | |
| component | 1,6-HD | | | 100 | 50 | |
| (molar ratio) | Bio-1,3-PD | 100 | 100 | | | 100 |

| | | | | | |
|---|---|---|---|---|---|
| Hydroxyl value (mgKOH/g) | 37.3 | 37.3 | 57.0 | 37.4 | 37.4 |
| Acid value (mgKOH/g) | 0.3 | 0.3 | 0.4 | 0.3 | 0.3 |
| Number average molecular weight | 3000 | 3000 | 2000 | 3000 | 3000 |
| Bio % | 100 | 100 | 81.1 | 0 | 100 |

The abbreviations in Table 3 are as described below.

NPG: Neopentyl glycol

1,6-HD: 1,6-Hexanediol

1,3-PD: 1,3-Propanediol

TABLE 4
Combinations and characteristics of urethane resin solutions of Comparative
Examples

| Polyurethane | | Comparative Example | | | | | | | |
|---|---|---|---|---|---|---|---|---|---|
| resin | | 1 | 2 | 3 | 4 | 5 | 6 | 7 | 8 |
| solution No. | | PU-C1 | PU-C2 | PU-C3 | PU-C4 | PU-05 | PU-C6 | PU-C7 | PU-C8 |
| Urethane | No. | (C1) | (C2) | (C3) | (C4) | (C5) | (C6) | (C7) | (C8) |
| prepolymer | PE (2) | | | 180 | | | | | |
| solution | PE (4) | | | 320 | | | | | |
| | PE (6) | | | | | 500 | 500 | | |
| | PE (13) | 500 | | | | | | | |
| | PE (14) | | 500 | | | | | | |
| | PE (15) | | | | 500 | | | | |
| | PE (16) | | | | | | | 500 | |
| | PE (17) | | | | | | | | 500 |
| | IPDI | 66.4 | 62.7 | 59.0 | 111.0 | 72.2 | 59.2 | 66.6 | 66.6 |
| | NCO % | 1.87 | 1.65 | 1.42 | 3.36 | 2.20 | 1.42 | 1.87 | 1.87 |
| | Ethyl | 188.8 | 187.6 | 186.4 | 203.7 | 190.7 | 186.4 | 188.9 | 188.9 |
| | acetate | | | | | | | | |

| | | | | | | | | |
|---|---|---|---|---|---|---|---|---|
| IPDA | 23.8 | 20.9 | 18.2 | 38.8 | 32.0 | 16.5 | 23.5 | 23.5 |
| Ethyl aetate | 981.9 | 969.9 | 958.5 | 1100.6 | 1007.3 | 955.6 | 981.1 | 981.1 |
| IPA | 206.6 | 204.3 | 202.0 | 230.2 | 211.5 | 201.5 | 206.5 | 206.5 |
| Solid content (%) | 30 | 30 | 30 | 30 | 30 | 30 | 30 | 30 |
| Viscosity/mPas | 1090 | 1180 | 1100 | 1020 | 800 | 1700 | 1180 | 1200 |
| (25° C.) | | | | | | | | |
| Amino group | 47.1 | 41.7 | 42.7 | 42.5 | 127.0 | 8.8 | 41.0 | 41.0 |
| equivalent | | | | | | | | |
| (μeq/g) | | | | | | | | |
| Bio % | 84.7 | 85.7 | 31.2 | 61.6 | 82.3 | 86.9 | 0 | 84.7 |

The abbreviations in Table 4 are as described below.

IPDI: Isophorone diisocyanate

IPDA: Isophorone diamine

IPA: Isopropyl alcohol

<Evaluation>

A printing ink in which each resin solution was blended therein was prepared in the manner as described below, and evaluation of the performance of each polyurethane resin solution of Examples and Comparative Examples was performed using the obtained printing ink.

[Preparation of Printing Ink: Examples 1-I to 13-I and Comparative Examples 1-I to 8-I]

Printing inks of Examples and Comparative Examples were each prepared using 40 parts of respective polyurethane resin solutions of Examples 1 to 13 and Comparative Examples 1 to 8 in the manner as described below. Specifically, a mixture having a composition composed of 30 parts of titanium oxide white as a pigment, 40 parts of each polyurethane resin solution, 15 parts of n-propyl acetate, and 15 parts of isopropyl alcohol was kneaded with a paint shaker for 1 hour to prepare each white ink. Further, the viscosity of the obtained white ink was adjusted with a mixed solvent of ethyl acetate/IPA (mass ratio of 50/50) for dilution so as to be 18 seconds when measured with a Zahn cup #3 to obtain each of the printing inks of Examples 1-I to 13-I and Comparative Examples 1-I to 8-I. It is to be noted that the printing inks prepared using respective polyurethane resin solutions of Examples 1 to 13 and Comparative Examples 1 to 8 were each denoted with “-I” attached to the number for the Example or the Comparative Example.

(Method for Evaluating Printing Ink and Evaluation Criteria)

Printing inks of Examples 1-I to 13-I and Comparative Examples of 1-I to 8-I prepared above were each used and evaluated according to the testing methods and criteria described below, and the results are shown together in Table 5.

(1) Amount of Biomass Components

The content (% by mass) of the biomass components in the biomass urethane resin in the solid content of each printing ink of Examples and Comparative Examples was determined by calculation and evaluated according to the following criteria.

### (Evaluation Criteria)

Good: The amount of the biomass components is 10% or more.

Poor: The amount of the biomass components is less than 10%.

(2) Compatibility

A standard ink was prepared for evaluation in the manner as described below in order to evaluate the compatibility with a petroleum-derived, standard printing ink. Firstly, 500 parts of the polyester diol PE (4) having 100% of the petroleum-derived components and 66.4 parts of IPDI were loaded in a reaction container and reacted at 100° C. for 5 hours in a nitrogen gas stream to obtain a urethane prepolymer having an NCO group content of 1.87%. Next, the obtained urethane prepolymer was dissolved in 188.8 parts of ethyl acetate, which is an organic solvent for dilution, to make a urethane prepolymer solution having a non-volatile content of 75%. Subsequently, a mixture (diamine solution) of 23.6 parts of IPDA, 981.4 parts of ethyl acetate, and 206.5 parts of IPA was blended, 755.2 parts of the urethane prepolymer solution obtained above was dropped in the mixture under stirring, and a resultant mixture was reacted at 40° C. for 1 hour. As a result, a polyurethane resin solution having a non-volatile content of 30%, a viscosity of 1150 mPa·s (25° C.), and a terminal amino group concentration of 42.8μ equivalent per 1 g of the solid content of the resin, and not having a plant-derived component in the solid content of the resin was obtained.

A mixture having a composition composed of 40 parts of the obtained polyurethane resin solution, 30 parts of titanium oxide white, 15 parts of n-propyl acetate, and 15 parts of IPA was kneaded with a paint shaker for 1 hour to prepare a white ink. Further, the viscosity of the obtained white ink was adjusted with a mixed solvent of ethyl acetate/isopropyl alcohol (mass ratio of 50/50) for dilution so as to be 18 seconds when measured with a Zahn cup #3 to obtain a standard printing ink (100% derived from petroleum) for evaluating compatibility.

Into a cup, 100 parts of the standard printing ink for evaluating compatibility prepared above was taken out, and 100 parts of each of the inks 1-I to 13-I of Examples and the inks 1-I to 8-I of Comparative Examples was taken out into a cup and was poured into the standard printing ink to observe the state on that occasion visually and evaluate the compatibility with the standard printing ink according to the criteria described below.

(Evaluation Criteria)

Excellent: The resultant mixture becomes uniform by only mixing.

Good: The resultant mixture is ununiform by only mixing, but becomes uniform when stirred.

Poor: The resultant mixture does not become uniform even if it is stirred.

(3) Pigment Dispersibility

A small amount of each printing ink of Examples and Comparative Examples was dropped on white paper with a black band printed thereon, and the dropped ink was spread with a metal spatula to observe the uniformity of pigment dispersion and the color developability visually and evaluate them according to the following criteria.

(Evaluation Criteria)

Good: The pigment dispersion is uniform, and the color development is favorable.

Fair: The pigment dispersion is somewhat ununiform, and the color development is somewhat unfavorable.

Poor: The pigment dispersion is ununiform, and the color development is clearly inferior.

(4) Printability

The printing inks of Examples and Comparative Examples were separately set in a gravure printing machine with a gravure plate having a plate depth of 35 μm installed therein, and a change in the color development on the first printed matter before and after rotating the plate for 30 minutes under an environment of 25° C. with a doctor blade being in contact with the plate was observed visually and evaluated according to the following criteria. The base material of the printed matter was a corona discharge-treated, biaxially stretched biomass PET having a thickness of 12 μm.

(Evaluation Criteria)

Good: There is no difference in the color development of printing before and after the rotation in the gravure printing machine for 30 minutes.

Fair: The color development after the rotation in the gravure printing machine for 30 minutes is somewhat inferior to the color development at the time when the rotation is started.

Poor: The color development after the rotation in the gravure printing machine for 30 minutes is clearly inferior to the color development at the time when the rotation is started.

(5) Adhesion Property (Tape Adhesion Test)

The printing inks of Examples and Comparative Examples were separately set in a gravure printing machine with a gravure plate having a plate depth of 35 μm installed therein, and printing was performed twice so as to be overlaid on a corona discharge-treated, biaxially stretched biomass PET film base material having a thickness of 12 μm to obtain each white-printed film for evaluation after drying at 50° C.

The adhesiveness of each ink after each of the obtained white-printed films was left to stand for 1 day was evaluated by a tape adhesion test performed using a cellophane tape (CELLOTAPE (R), 24 mm, manufactured by Nichiban Co., Ltd.). Specifically, the cellophane tape was stuck to a printed face of each white-printed film, the state of the printed film at the time when the cellophane tape was peeled at an angle of 90° without stopping was observed visually, and the quality of the adhesion property of the printing ink was decided by the residual rate of the ink left on the printed face. In the tape adhesion test, when the residual rate of a printing ink is 90% or more, the printing ink has sufficient practicability.

TABLE 5
Evaluation results of printing inks

| | | Amount of biomass | | | | | Adhesion property | |
|---|---|---|---|---|---|---|---|---|
| Printing ink | Resin | components | | | Pigment | | Visual | Residual |
| No. | component | Evaluation | (%) | Compatibility | dispersibility | Printability | evaluation | ink (%) |
| Ex. 1-I | PU1 | Good | 24.2 | Good | Good | Good | Good | 100 |
| Ex. 2-I | PU2 | Good | 23.2 | Good | Good | Good | Good | 100 |
| Ex. 3-I | PU3 | Good | 24.7 | Good | Good | Good | Good | 100 |
| Ex. 4-I | PU4 | Good | 12.0 | Good | Good | Good | Good | 100 |
| Ex. 5-I | PU5 | Good | 10.5 | Good | Good | Good | Good | 100 |
| Ex. 6-I | PU6 | Good | 24.2 | Good | Good | Good | Good | 100 |
| Ex. 7-I | PU7 | Good | 24.2 | Good | Good | Good | Good | 100 |
| Ex. 8-I | PU8 | Good | 24.2 | Good | Good | Good | Good | 100 |
| Ex. 9-I | PU9 | Good | 15.1 | Excellent | Good | Good | Good | 100 |
| Ex. 10-I | PU10 | Good | 11.7 | Excellent | Good | Good | Good | 100 |
| Ex. 11-I | PU11 | Good | 11.6 | Excellent | Good | Good | Good | 100 |
| Ex. 12-I | PU12 | Good | 13.4 | Excellent | Good | Good | Good | 100 |
| Ex. 13-I | PU13 | Good | 24.4 | Excellent | Good | Good | Good | 100 |
| C.Ex. 1-I | PU-C1 | Good | 24.2 | Good | Fair | Poor | Good | 100 |
| C.Ex. 2-I | PU-C2 | Good | 24.5 | Good | Fair | Poor | Poor | 0 |
| C.Ex. 3-I | PU-C3 | Poor | 8.9 | Good | Good | Good | Good | 100 |
| C.Ex. 4-I | PU-C4 | Good | 17.6 | Good | Fair | Poor | Good | 100 |
| C.Ex. 5-I | PU-C5 | Good | 23.7 | Good | Fair | Fair | Poor | 0 |
| C.Ex. 6-I | PU-C6 | Good | 24.8 | Good | Fair | Poor | Poor | 0 |
| C.Ex. 7-I | PU-C7 | Poor | 0 | Excellent | Good | Good | Good | 100 |
| C.Ex. 8-I | PU-C8 | Good | 24.2 | Good | Fair | Poor | Poor | 0 |

Ex. represents Example
C.Ex. represents Comparative Example

1. A bio-polyurethane resin obtained by reacting a bio-polyol component (A) and an isocyanate component (B), wherein:
the bio-polyol component (A) is a bio-polyester polyol being a polymerized product of a multifunctional alcohol component and a multifunctional carboxylic acid component, the polymerized product obtained from a raw material comprising: a diol component (a) comprising a plant-derived component; and a dicarboxylic acid component (b) comprising a plant-derived component;
the diol component (a) comprises at least one selected from the group consisting of ethylene glycol, 1,2-propanediol, 1,3-propanediol, 1,4-butanediol, 1,10-decanediol, and dimer diols each derived from a plant;
the dicarboxylic acid component (b) comprises plant-derived succinic acid and an additional dicarboxylic acid, and a molar ratio thereof, plant-derived succinic acid/additional dicarboxylic acid, is 98/2 to 5/95; and
a content of plant-derived components is 35% by mass or more based on 100% by mass of the bio-polyurethane resin.

2. The bio-polyurethane resin according to claim 1, wherein the additional dicarboxylic acid is at least any one of plant-derived sebacic acid or dimer acids.

3. The bio-polyurethane resin according to claim 1, further comprising a polyamine component (C) as a reaction component and having a urethane urea bond in a structure thereof

4. The bio-polyurethane resin according to claim 3, having an active amino group at a terminal thereof, wherein the terminal active amino group has a concentration of 15 to 100μ equivalent per 1 g of a solid content of the bio-polyurethane resin.

5. The bio-polyurethane resin according to claim 1, further comprising an organic solvent, wherein:
the bio-polyurethane resin is dissolved in the organic solvent and is in a form of a solution; and
the organic solvent does not contain toluene or does not contain any of toluene and methyl ethyl ketone.

6. A bio-polyurethane resin solution being a polyester-based polyurethane resin solution comprising:
a polyester-based polyurethane resin obtained by polymerizing a polyester polyol, an organic diisocyanate, and a polyamine, having a urethane urea bond in a structure thereof, and having an active amino group at a terminal thereof; and
an organic solvent, wherein:
the polyester polyol is a polymerized product of a multifunctional carboxylic acid component and a multifunctional alcohol component each obtained from a raw material for synthesis comprising a plant-derived component;
the multifunctional carboxylic acid component comprises a dimer acid and succinic acid in a range where a molar ratio of plant-derived succinic acid/dimer acid is 98/2 to 5/95, and the multi-functional alcohol component comprises 1,3-propanediol; and
a proportion of plant-derived components in a solid content of the polyester-based polyurethane resin having an active amino group at a terminal thereof is 35% by mass or more.

7. The bio-polyurethane resin solution according to claim 6, wherein part of or all of the succinic acid is a plant-derived component, and part of or all of the dimer acid is a plant-derived component and/or part of or all of the 1,3-propanediol is a plant-derived component.

8. The bio-polyurethane resin solution according to claim, wherein the terminal active amino group in the polyester-based polyurethane resin having the active amino group at the terminal thereof has a concentration of 15 to 100μ equivalent per 1 g of a solid content of the polyester-based polyurethane resin.

9. The bio-polyurethane resin solution according to claim 6, wherein the organic solvent does not contain toluene or does not contain any of toluene and methyl ethyl ketone.

10. The bio-polyurethane resin solution according to claim 6, wherein the organic solvent is a mixed solvent of ethyl acetate and isopropyl alcohol, or a mixed solvent of ethyl acetate, isopropyl alcohol, and methyl ethyl ketone.

11. A printing ink comprising:
a pigment; and
a binder for a printing ink, wherein
the bio-polyurethane resin solution according to any one of claim 6 in an amount such that a proportion of plant-derived components in a solid content of the ink is 10% by mass or more as the binder for a printing ink.

12. The printing ink according to claim 11, to be used for gravure printing, flexographic printing, screen printing, offset printing, or inkjet printing.

13. The printing ink according to claim 11, to be used for printing onto a film package, a paper package, a building material, or tissue paper.

14. A printing ink comprising:
a pigment; and
a binder for a printing ink, wherein
the printing ink comprises the bio-polyurethane resin in the form of a solution according to claim 5 in an amount such that a proportion of plant-derived components in a solid content of the ink is 10% by mass or more as the binder for a printing ink.
